(19) United States
(12) Patent Application Publication
(10) Pub. No.: US 2014/0029240 A1
(43) Pub. Date: Jan. 30, 2014

(54) Backlight System and Flat Panel Display Device

(71) Applicants: Yu-chun Hsiao, Shenzhen (CN); Yi-cheng Kuo, Shenzhen (CN); Chong Huang, Shenzhen (CN)

(72) Inventors: Yu-chun Hsiao, Shenzhen (CN); Yi-cheng Kuo, Shenzhen (CN); Chong Huang, Shenzhen (CN)

(73) Assignee: SHENZHEN CHINA STAR OPTOELECTRONICS TECHNOLOGY CO. LTD., Shenzhen (CN)

(21) Appl. No.: 13/580,138

(22) PCT Filed: Jul. 27, 2012
(86) PCT No.: PCT/CN12/79236

§ 371 Date: Aug. 20, 2012

(30) Foreign Application Priority Data
Jul. 24, 2012 (CN) 201210257653.9

(51) Int. Cl. F21V 21/00

(52) U.S. Cl. CPC F21V 21/00
USPC 362/97.1

(57) ABSTRACT

The present invention provides a backlight system containing a uniforming device, a reflection plate, a back frame, and a PET (Polyethylene Terephthalate) substrate. The uniforming device is placed on the back frame with the PET substrate configured in between. The reflection plate is configured between the uniforming device and the PET substrate. The back frame contains at least a first main piece and a second main piece jointly forming a main frame of the back frame. The present invention also provides a flat panel display device capable of preventing the light leakage and the cave-in of the reflection plate.

### BACKGROUND OF THE INVENTION

1. Field of the Invention

The present invention relates to the field of liquid crystal displaying techniques, and in particular to a backlight system and a flat panel display device.

2. The Related Arts

According to existing technology, a liquid crystal display (LCD) device contains a front frame, display panel, and a backlight system. The backlight system contains a back frame, reflection plate, and light assembly.

Currently the LCD devices on the market are of various dimensions so as to fit consumers' requirements. Taking LCD TV as example, the display panel can be 31.5″, 42″, 36″, 48″, or 55″. For display panels of different dimensions, different back frames have to be prepared.

FIG. 1 is a schematic diagram showing the structure of a back frame of a conventional LCD device. As illustrated, the conventional back frame 10 is integrally formed usually by metal stamping or plastic injection molding. The integrally-formed back frame 10 consumes more material and therefore has a higher material cost. In addition, a large-sized back frame 10 requires a larger stamping apparatus. The mold for a large-sized back frame 10 is also bigger and structurally more complex, contributing to a higher molding cost. Therefore, in general, a large-sized, integrally-formed back frame 10 is more expensive to manufacture.

On the other hand, the reflection plate contains a reflection layer and a substrate layer, and the reflection plate is formed by joining the two together. The reflection plate is then placed on the back frame, and the light guide plate and optical film are further stacked on the reflection plate.

A major drawback of an existing backlight system is that, as the back frame requires stamped protrusions or reinforced ribs to enhance its strength and the back frame as such does not provide a complete solid and flat support surface, the reflection plate placed on the back frame is often caved in due to its inferior strength. The optical quality of the backlight system is therefore compromised.

### SUMMARY OF THE INVENTION

The technical issue to be addressed by the present invention is to provide a backlight system and a flat panel display device capable of preventing the light leakage and the cave-in of reflection plate.

To resolve the technical issue, the present invention provides a backlight system containing a uniforming device, a reflection plate, a back frame, and a PET (Polyethylene Terephthalate) substrate. The uniforming device is placed on the back frame with the PET substrate configured in between; the reflection plate is configured between the uniforming device and the PET substrate; the PET substrate is of color black; the PET substrate is adhered to the back frame; and the back frame contains at least two main pieces jointly forming a main frame of the back frame.

Preferably, the reflection plate contains a substrate layer and a reflection layer on the substrate layer; and the substrate layer contacts the PET substrate.

To resolve the technical issue, the present invention provides another backlight system containing a uniforming device, a reflection plate, a back frame, and a PET substrate. The uniforming device is placed on the back frame with the PET substrate configured in between; the reflection plate is configured between the uniforming device and the PET substrate; and the back frame contains at least two main pieces jointly forming a main frame of the back frame.

Preferably, the PET substrate is of color black.

Preferably, the reflection plate contains a substrate layer, a reflection layer on the substrate layer; and an ink layer printed on a side of the substrate layer away from the reflection layer.

Preferably, the PET substrate is adhered to the back frame.

To resolve the technical issue, the present invention provides a flat panel display device containing a display panel and a backlight system stacked together. The backlight system contains an uniforming device, a reflection plate, a back frame, and a PET substrate; the uniforming device is placed on the back frame with the PET substrate configured in between; the reflection plate is configured between the uniforming device and the PET substrate; and the back frame contains at least two main pieces jointly forming a main frame of the back frame.

Preferably, the PET substrate is of color black.

Preferably, the reflection plate contains a substrate layer and a reflection layer on the substrate layer; and the substrate layer contacts the PET substrate.

Preferably, the PET substrate is adhered to the back frame.

Preferably, the back frame further contains at least an auxiliary piece and a brace; the auxiliary piece is configured in the main frame and joined to the main pieces; the brace is fixed to the main pieces or the auxiliary piece; and the brace is for fixing a circuit board.

Preferably, the main pieces contains a first main piece and a second main piece; at least two joining section is configured at an end of the first main piece; each joining section is structured to match an end of a second main piece; and the first main piece is joined to a second main piece by having one of its joining sections connected to an end of the corresponding second main piece.

Preferably, the joining sections are arranged at an interval along the length of the first main piece.

Preferably, each joining section is an indentation on a surface of the first main piece whose shape matches an end of a second main piece so as to receive the end of the second main piece.

Preferably, a protrusion is configured on a surface at the end of the second main piece; and the protrusion is received by a notch in the corresponding joining section so that the first and second main pieces are joined together.

Preferably, there are at least two protrusions arranged at intervals on a surface along the length of the second main piece.

In contrast to the prior arts, the present invention has the following advantages. By configuring at least two main pieces, and by forming the main structure of the back frame by joining the first and second main pieces, the back frame of the present invention is structurally simple, and reduces material consumption and cost of molds. By having a PET substrate on the back frame and then having reflection plate, light guide plate, etc. on the PET substrate, the light leakage problem can be effective prevented. Additionally, the PET substrate has a certain mechanical strength, thereby preventing the cave-in of the reflection plate.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic diagram showing the structure of a back frame of a conventional LCD device;

FIG. 2 is a schematic diagram showing the structure of a flat panel display device according to a first embodiment of the present invention;

FIG. 3 is a schematic diagram showing the structure of a back frame of a flat panel display device according to a second embodiment of the present invention;

FIG. 4 is a schematic diagram showing the structure of a back frame of a flat panel display device according to a third embodiment of the present invention;

FIG. 5 is a schematic diagram showing the structure of a back frame of a flat panel display device according to a fourth embodiment of the present invention;

FIG. 6 is a schematic diagram showing the assembly structure of a flat panel display device according to a fifth embodiment of the present invention;

FIG. 7 is a schematic diagram showing a first auxiliary piece diagonally configured on a main frame of a flat panel display device according to a sixth embodiment of the present invention;

FIG. 8 is a schematic diagram showing a first auxiliary piece and a second auxiliary piece configured on a main frame of a flat panel display device according to a sixth embodiment of the present invention;

FIG. 9 is a schematic diagram showing the structure of a back frame's joining section of a flat panel display device according to a eighth embodiment of the present invention;

FIG. 10 is a cross-sectional diagram showing the joining section of FIG. 9;

FIG. 11 is a cross-sectional diagram showing the structure of a back frame's joining section of a flat panel display device according to a ninth embodiment of the present invention;

FIG. 12 is a cross-sectional diagram showing the structure of a back frame's joining section of a flat panel display device according to a tenth embodiment of the present invention;

FIG. 13 is a cross-sectional diagram showing the structure of a back frame's joining section of a flat panel display device according to a eleventh embodiment of the present invention;

FIG. 14 is a schematic diagram showing the structure of a back frame's joining section of a flat panel display device according to a twelfth embodiment of the present invention;

FIG. 15 is a schematic diagram showing the structure of a back frame's joining section of a flat panel display device according to a thirteenth embodiment of the present invention;

FIG. 16 is flow diagram showing the steps of producing a back frame of a flat panel display device according to a fourteenth embodiment of the present invention;

FIG. 17 is a schematic diagram showing the structure of a flat panel display device with a touch panel according to a fifteenth embodiment of the present invention;

FIG. 18 is a schematic diagram showing the structure of a 3D display device according to a sixteenth embodiment of the present invention;

FIG. 19 is a schematic diagram showing the structure of a plasma display device according to a seventeenth embodiment of the present invention;

FIG. 20 provides an application scenario of a backlight system of the flat panel display device of FIG. 2; and

FIG. 21 is schematic diagram showing the structure of a reflection plate according to a first embodiment of the present invention.

### DETAILED DESCRIPTION OF THE PREFERRED EMBODIMENTS

Together with the accompanied drawings, detailed description to the various embodiments of the present invention is provided as follows.

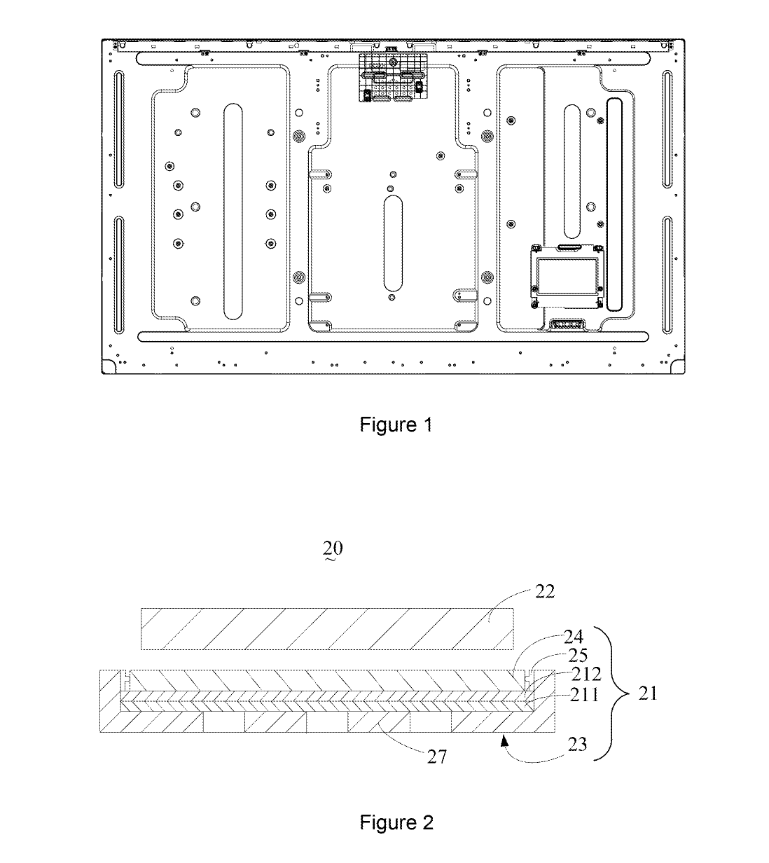

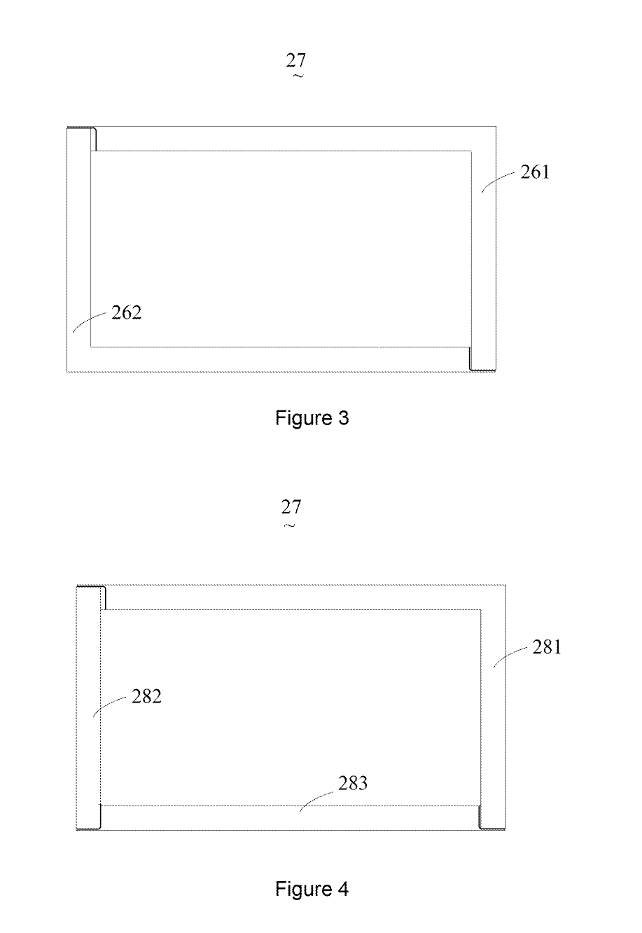

FIG. 2 is a schematic diagram showing the structure of a flat panel display device according to a first embodiment of the present invention. FIG. 3 is a schematic diagram showing the structure of a back frame to a flat panel display device according to a second embodiment of the present invention. As illustrated in FIG. 2, the flat panel display device 20 contains a backlight system 21 and display panel 22. The backlight system 21 is configured behind the display panel 22 and provides illumination to the display panel 22.

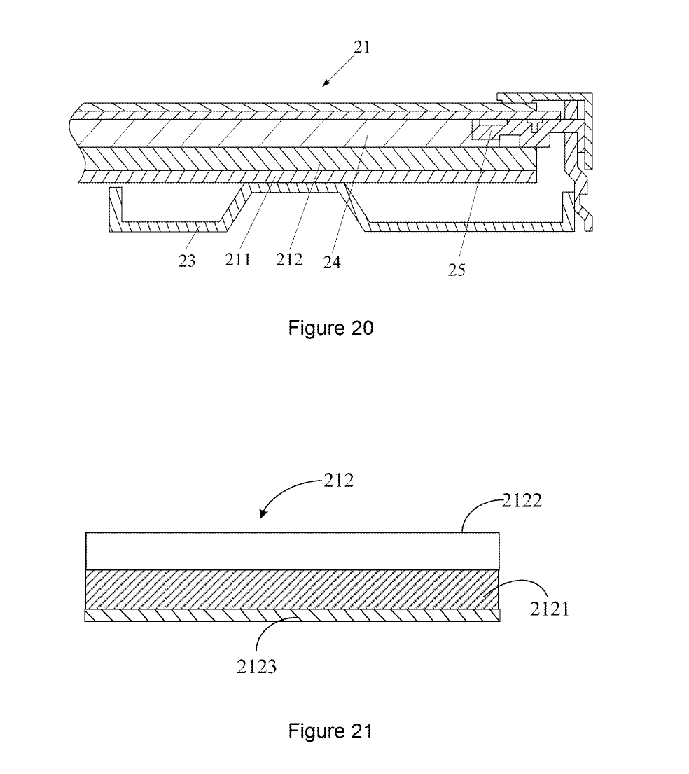

As also shown in FIG. 20, the backlight system 21 contains a light source 25, a uniforming device 24, and a back frame 23. The backlight system 21 also contains a PET (Polyethylene Terephthalate) substrate 211 and a reflection plate 212. The back frame 23 supports the light source 25 and uniforming device 24. If this is an edge-lit backlight system 21, the uniforming device 24 is a light guide plate. If this is a direct-lit backlight system 21, the uniforming device 24 is a diffusing film. The uniforming device 24 is placed on the back frame 23 with the PET substrate 211 configured in between. The reflection plate 212 is in turn configured between the uniforming device 24 and the PET substrate 211. The PET substrate 211 is attached to the back frame 23 by adhesion. The back frame 23 contains at least a first main piece and a second main piece jointly forming a main frame 27 of the back frame 23.

In an embodiment of the present invention, the PET substrate 211 is black, and the light emitted from the light source 25 is blocked by the black PET substrate 211 as the light travels through the uniforming device 24 and into the reflection plate 212. This prevents the light leakage problem resulted from the light penetrating through the reflection plate 212 and into the main frame 27 of the back frame 23. In addition, as the PET substrate 211 has a certain mechanical strength, the cave-in of the reflection plate 212 can be prevented, thereby enhancing the quality of the flat panel display device.

Of course the PET substrate 211 can be white or of other color, and black ink or ink of other color or no ink printed on a side of the PET substrate 211 interfacing the reflection plate 212 can also resolve the light leakage problem to a certain degree. The details are omitted here.

In another embodiment, together with FIG. 21, the reflection plate 212 contains a substrate layer 2121, a reflection layer 2122, and an ink layer 2123 printed on a side of the substrate layer 2121 away from the reflection layer 2122. The ink layer 2123 contacts the PET substrate 211 and is of color black. As the light from the light source 25 penetrates into the reflection layer 212 through the uniforming device 24, a portion of it passes through the reflection layer 2122, the substrate layer 2121, and then is blocked by the ink layer 2123. This prevents the light leakage problem resulted from the light penetrating through the substrate layer 2121 of the reflection plate 212 and into the main frame 27 of the back frame 23. The light efficiency of the light source 25 is as such enhanced. Even though a portion of the light can still penetrate the ink layer 2123, this portion of the light will still be blocked by the PET substrate 211. In other words, with double insurance by having the ink layer 2123 behind the reflection plate 212 and PET substrate 211, the light leakage from the reflection plate 212 to the back frame 23 can be maximally avoided, the risk of having light leakage after the backlight system 21 is assembled is reduced, and the performance of the backlight system 21 is enhanced.

Of course, it is not necessary to have the ink layer 2123 on a side of the substrate layer 2121 away from the reflection layer 2122. In this case, the substrate layer 2121 contacts the PET substrate 211 and the PET substrate 211 is black. Then, for the light emitted from the light source 25 and as the light penetrates into the reflection plate 212 through the uniforming device 24, a portion of it will penetrate through the reflection plate 2122 and the substrate layer 2121, and eventually be blocked the PET substrate 211, thereby preventing the light leakage problem resulted from the light penetrating through the substrate layer 2121 of the reflection plate 212 and into the main frame 27 of the back frame 23. The light efficiency of the light source 25 is as such enhanced.

As shown in FIG. 3, a first embodiment of the back frame 23 contains a first main piece 261 and a second main piece 262. An end of the first main piece 261 is joined to an end of the second main piece 262, and another end of the first main piece 261 is joined to another end of the second main piece 262, thereby forming the main frame 27 of the back frame 23. The first and second main pieces 261 and 262 are made of aluminum or zinc-plated steel. In the present embodiment, the first and second main pieces 261 and 262 are L-shaped.

As shown in FIG. 4, a second embodiment of the back frame 23 contains a first main piece 281, a second main piece 282, and a third main piece 283, jointly forming the main frame 27 of the back frame 23. The first, second, and third main pieces 281, 282, and 283 are made of aluminum or zinc-plated steel. In the present embodiment, the first main pieces 281 is L-shaped, the second and third main pieces 282 and 283 are elongated rectangles.

The back frame 23 can further contain auxiliary pieces configured in the main frame 27.

In the following embodiments, the back frame 23 of the flat panel display device 20 involves four main pieces and two auxiliary pieces.

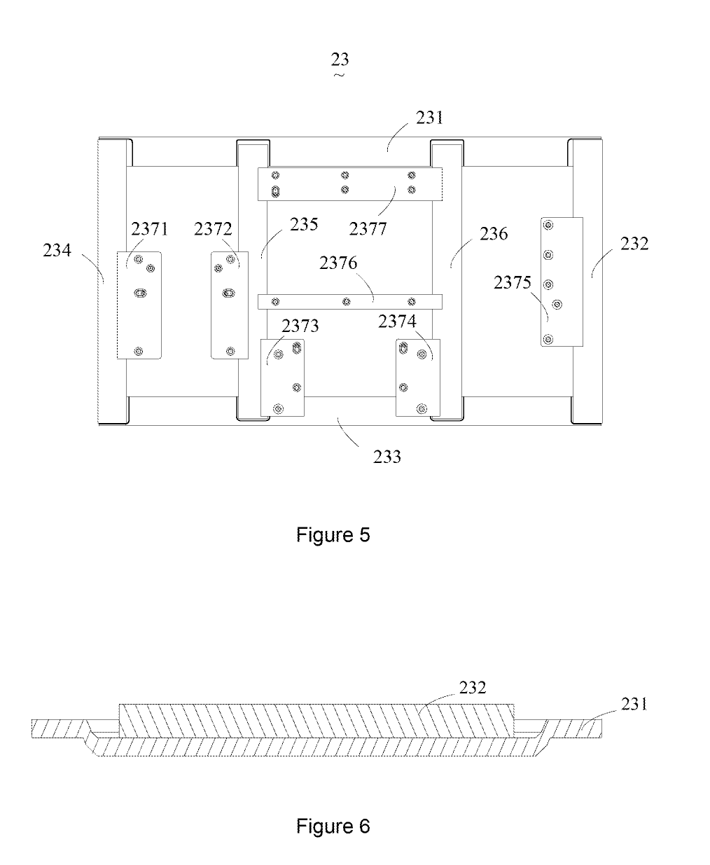

FIG. 5 is a schematic diagram showing the structure of a back frame of a flat panel display device according to a fourth embodiment of the present invention. As illustrated, the back frame 23 contains a first main piece 231, a second main piece 232, a third main piece 233, a fourth main piece 234, a first auxiliary piece 235, a second auxiliary piece 236, and braces 2371, 2372, 2373, 2374, 2375, 2376, and 2377. The first to fourth main pieces 231, 232, 233, and 234 jointly form the main frame 27 of the back frame by end-to-end connection with each other. The first and second auxiliary pieces 235 and 236 are configured in and joined to the main frame 27.

Specifically, an end of the first main piece 231 is joined to an end of the second main piece 232, another end of the second main piece 232 is joined to an end of the third main piece 233, another end of the main piece 233 is joined to an end of the fourth main piece 234, and another end of the fourth main piece 234 is joined to another end of the first main piece 231, thereby forming the rectangular main frame 27. The first to fourth main pieces 231, 232, 233, and 234 are made of aluminum or zinc-plated steel. In the present embodiment, the first to fourth main pieces 231, 232, 233, and 234 are elongated rectangles. In alternative embodiments, the first to fourth main pieces 231, 232, 233, and 234 can all be L-shaped or some of them are elongated rectangles and some are L-shaped. For example, as shown in FIG. 3, the first and second main pieces 261 and 262 are both L-shaped and, as shown in FIG. 4, the first main piece 281 is L-shaped whereas the second and third main pieces 282 and 283 are elongated rectangles.

In the present embodiment, the back frame 23 of the flat panel display device 20 is assembled by piecing the main and auxiliary pieces together. As shown in FIG. 6, which exemplifies the connection of an end of the first main piece 231 and an end of the second main piece 232, an end of the second main piece 232 is joined to an end of the first main piece 231 by means such as bolting, fastening, or welding.

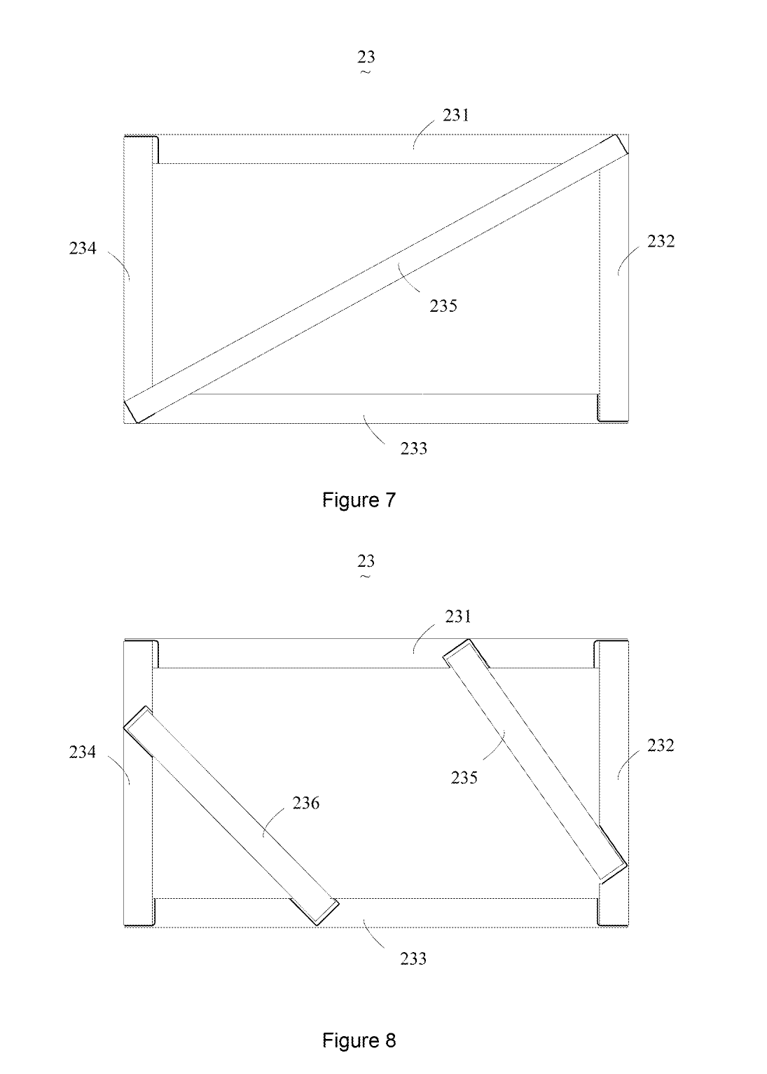

In the preset embodiment, the first and second auxiliary pieces 235 and 236 are configured in the main frame 27 of the back frame 23. An end of the first auxiliary piece 235 is joined to the first main piece 231, another end of the first auxiliary piece 235 is joined to the third main piece 233, an end of the second auxiliary piece 236 is joined to the first main piece 231, another end of the second auxiliary piece 236 is joined to the third main piece 233, and the second and fourth main pieces 232 and 234, the first and second auxiliary pieces 235 and 236 are arranged in parallel. In alternative embodiments, at least an auxiliary piece is configured in the main frame 27, such as having only the first auxiliary piece 235 configured in the main frame 27. In addition, the first auxiliary piece 235 can have its two ends joined to at least two of the first to fourth main pieces 231, 232, 233, and 234, such as the first auxiliary piece 235's configuration in the main frame 27 as shown in FIG. 7. Similarly, the second auxiliary piece 236 can have its two ends joined to at least two of the first to fourth main pieces 231, 232, 233, and 234, such as the first auxiliary piece 235's two ends are joined the neighboring first and second main pieces 231 and 232, respectively, and the second auxiliary piece 236's two ends are joined the neighboring third and fourth main pieces 233 and 234, respectively, as shown in FIG. 8.

In the present embodiment, the back frame 23 contains seven braces 2371, 2372, 2373, 2374, 2375, 2376, and 2377. The brace 2371 is fixed to the fourth main piece 234, the braces 2372 and 2373 are fixed to the first auxiliary piece 235, the brace 2374 is fixed to the second auxiliary piece 236, the brace 2375 is fixed to the second main piece 232, and the two ends of the braces 2376 and 2377 are fixed to the first and second auxiliary pieces 235 and 236, respectively. In fact, each brace can be fixed to one or more of the first to fourth main pieces 231, 232, 233, and 234, and the first and second auxiliary pieces 235 and 236. In alternative embodiments, braces of various numbers can be configured on the back frame 23 such as having one or more braces. In addition, each brace can be detachably fixed to one or more of the first to fourth main pieces 231, 232, 233, and 234, and the first and second auxiliary pieces 235 and 236.

The braces 2371, 2372, 2373, 2374, 2375, 2376, and 2377 all have protrusions configured (not shown), and circuit boards etc. are fixed to the back frame 23 through the protrusions.

In the following, the molds for the back frame 23 are described. In the present embodiment, the first and third main pieces 231 and 233 are of the same shape and dimension, and therefore can be stamped using the same mold. The second and fourth main pieces 232 and 234, and the first and second auxiliary pieces 235 and 236 are of the same shape and dimension, and therefore can be stamped using the same mold. In other words, the molds can be shared for the main and auxiliary pieces, and the back frame 23 can be produced using two molds of smaller dimensions, in contrast to the larger-dimensioned mold required by the conventional back frame 10. The molds for the back frame 23 of the present invention are smaller and structurally simpler, thereby reducing the cost of the molds for the back frame 23. On the other hand, compared to the integrally formed back frame 10, the back frame 23 of the present invention requires significantly less material and the flat panel display device 20 enjoys a lower production cost.

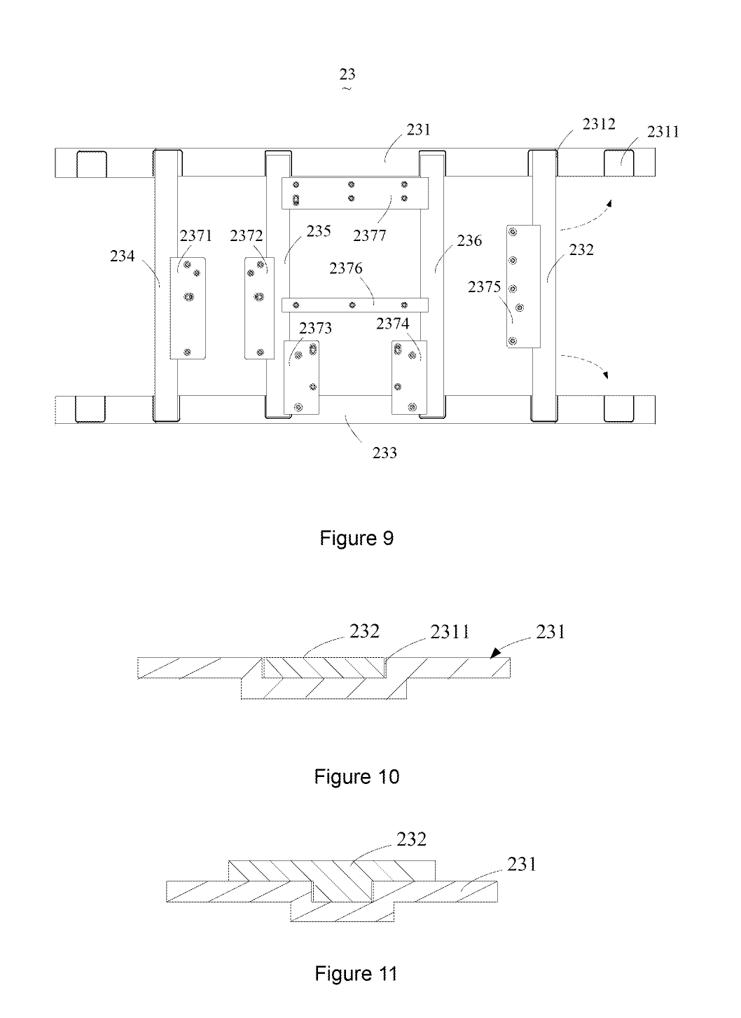

FIG. 9 is a schematic diagram showing the structure of a back frame of a flat panel display device according to an eighth embodiment of the present invention. As illustrated, an end of the first main piece has two joining sections structured to match an end of the second main piece so as to join the end of the second main piece to the first main piece.

Specifically, an end of the first main piece 231 has two joining sections 2311 and 2312 arranged at an interval along the length of the first main piece 231. The joining sections 2311 and 2312 are indentations on the first main piece 231 whose shapes match an end of the second main piece 232 so as to receive the end of the second main piece 232. As illustrated in FIG. 10, the joining sections 2311 and 2312 are indentations of a rectangular shape that does not run laterally completely across the first main piece 231. The second main piece 232 is an elongated rectangle.

To assemble the back frame 23 of a larger dimension, the joining section 2311 that is closer to the end of the first main piece 231, and a second main piece 232 of a compatible width are chosen. Then, an end of the second main piece 232 is placed in the joining section 2311 and, subsequently, the end of the second main piece 232 is joined to the joining section 2311 through bolting, fastening, or welding. To assemble the back frame 23 of a smaller dimension, the joining section 2312 that is farther from the end of the first main piece 231, and a second main piece 232 of a compatible width are chosen. Then, an end of the second main piece 232 is placed in the joining section 2312 and, subsequently, the end of the second main piece 232 is joined to the joining section 2312 through bolting, fastening, or welding. Alternatively, a protrusion can be configured on a surface at the end of the second main piece 232 and the protrusion is received by a notch in the joining section 2311 or 2312 so that the first and second main pieces 231 and 232 are joined together, as shown in FIG. 11. Additionally, there can be two, three, or four protrusions arranged at intervals on a surface along the length of the second main piece 232.

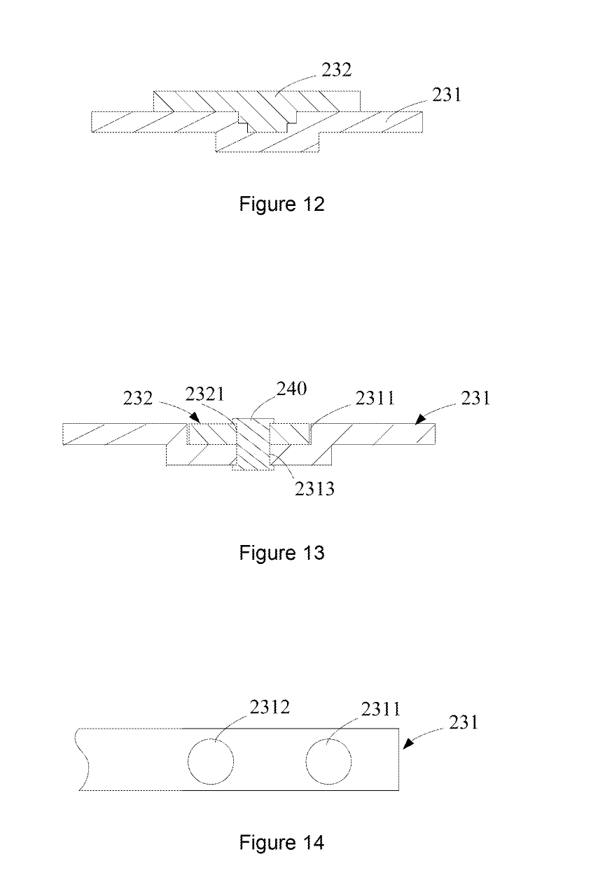

Furthermore, the joining sections 2311 or 2312 of the first main piece 231 can be a stepped indentation and correspondingly the second main piece 232 is configured with a stepped protrusion, as shown in FIG. 12. In addition, using the joining section 2311 as example as shown in FIG. 13, a first through hole 2313 is configured in the joining section 2311 and a second through hole 2321 is configured at a corresponding location on the second main piece 232. The back frame 23 further contains a fastener 240 running through the first and second through holes 2313 and 2321 so as to join the first and second main pieces 231 and 232 together.

As shown in FIG. 14 where the structure of a back frame of a flat panel display device according to another embodiment of the present invention is depicted, the joining sections 2311 and 2312 of the first main piece 231 are circular. Alternatively, the joining sections 2311 and 2312 can also be of a triangular shape or other polygonal shape.

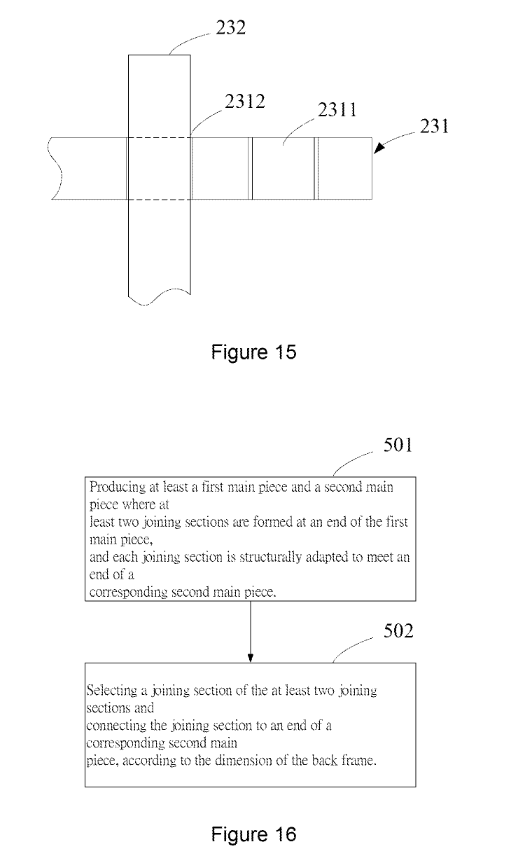

As shown in FIG. 15 where the structure of a back frame of a flat panel display device according to another embodiment of the present invention is depicted, the joining sections 2311 and 2312 are indentations of a rectangular shape that runs laterally completely across the first main piece 231. As such, the end of the second main piece 232 can move along the joining section 2311 or 2312. For example, after the end of the second main piece 232 is joined to the joining section 2312, the extraneous part of the second main piece 232 that runs through of the joining section 2312 can be cut so as to adjust the length of the second main piece 232 as it functions as a main piece for the back frame 23.

The other end of the first main piece 231 and the both ends of the third main piece 233 all have two joining sections whose structures are identical to those of the joining sections 2311 and 2312. The both ends of the second and fourth main pieces 232 and 234, depending on different conditions, could be designed differently. The following are some examples.

In a first condition as shown in FIG. 10, nothing is configured at both ends of the second and fourth main pieces 232 and 234. In other words, their ends are identical structurally to the other parts. Then, when selecting the joining section 2311 (or 2312) of the first main piece 231 for connection (the other end is processed accordingly), the length of the second and fourth main pieces 232 and 234 are determined correspondingly so as to fit the various width requirements of the back frame 23. In other words, if the joining section 2311 that is closer to the end of the first main piece 231 is chosen, the second and fourth main pieces 232 and 234 are not cut, or are cut for a shorter section. If the joining section 2312 that is farther from the end of the first main piece 231 is chosen, the second and fourth main pieces 232 and 234 are both cut. Depending on the distance between the chosen joining section and the end of the first main piece 231, the cut section is longer or shorter accordingly.

In a second condition as shown in FIG. 11, which is similar to the previous condition, different protrusions are employed on the second and fourth main pieces 232 and 234 so as to join with the first and third main pieces 231 and 233, respectively, and to fulfill the width variation of the back frame 23. Similarly, when the joining section 2312 other than the joining section 2311 that is closer to the end of the first main piece 231 is chosen, the extraneous part of the second and fourth main pieces 232 and 234 are cut, before or after the connection.

The above conditions also apply to the embodiment when the main frame 27 of the back frame 23 is formed by joining two L-shaped main pieces.

In summary, the first main piece of the back frame 23 has at least two joining sections and the exact number of the joining sections can vary in accordance with requirement. The present embodiment is described with two joining sections 2311 and 2312. When preparing molds for the back frame 23, only two molds are required. One if for the first main piece and the other for the second main piece. The first main piece can be configured with a number of joining sections for assembling back frames 23 of different dimensions and, when assembling a back frame 23, appropriate joining section is chosen based on the dimension of the back frame 23. Through the joining section, the second main piece is joined to the joining section of the first main piece and the other joining sections of the first main piece outside the chosen joining section can be cut off so as to obtain the back frame 23 of desired dimension. In contrast to the prior art where back frames 10 of different dimensions require different molds, the back frame 23 of the present invention only requires a mold for the first main piece and a mold for the second main piece, fulfilling the demand of mold sharing. Additionally, the molds are structurally simple, thereby reducing the cost of the molds for the back frame.

The present invention also provides a mold for producing the back frame for a flat panel display device. The mold is configured with main patterns for the main pieces, and the main patterns are configured with sub patterns for the at least two joining sections at an end of the main pieces. The main pieces here are referred to the above-mentioned first and second main pieces. The joining sections are referred to the joining sections on the first main piece mentioned above. The details are omitted here.

As shown in FIG. 16, the present invention provides a method for producing a back frame for a flat panel display device. The method contains the following steps.

In step 501, at least a first main piece and a second main piece are produced. At least two joining sections are formed at an end of the first main piece, and each joining section is structurally adapted to meet an end of a corresponding second main piece.

In step 502, according to the dimension of the back frame, a joining section of the at least two joining sections is chosen and joined to an end of a corresponding second main piece.

In the present embodiment, when there is a joining section between the joining section for the second main piece and the end of the first main piece, before or after an end of the second main piece is joined to the chosen joining section, the other joining section outside the chosen joining section of the first main piece is cut off. The first main piece here is referred to the above-mentioned first main piece and the second main piece here is referred to the above-mentioned second main piece. The details are omitted here.

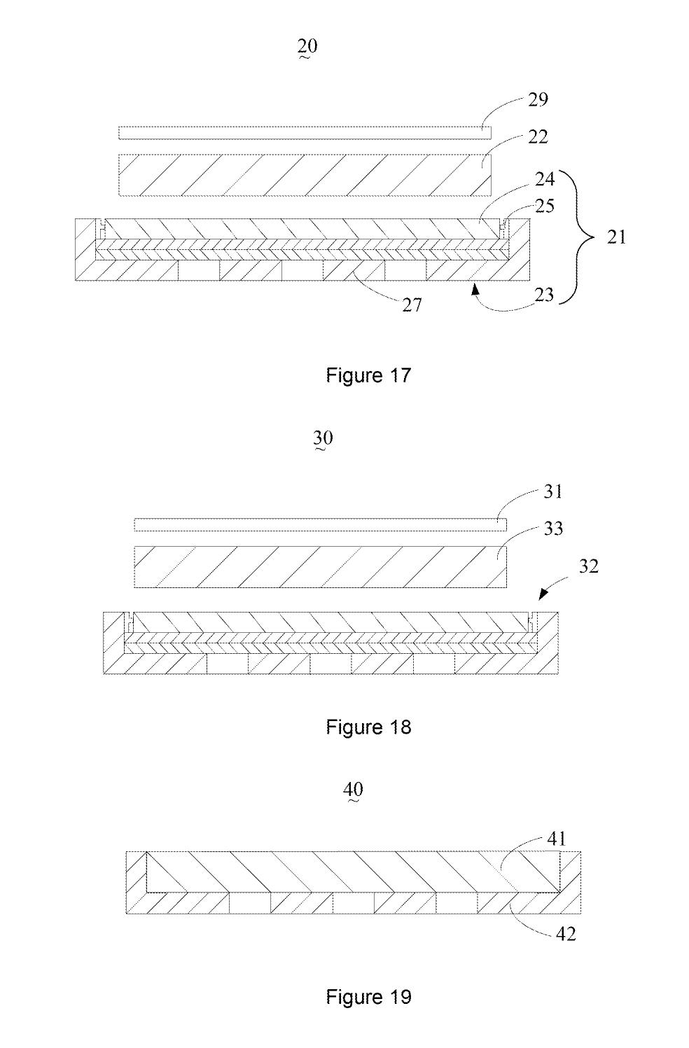

As shown in FIG. 17, the flat panel display device 20 of the present invention further contains a touch panel 29 configured on a light emission plane of the display panel 22 of the flat panel display device 20. The flat panel display device 20 contains a backlight system 21 and the above-mentioned display panel 22. The backlight system 21 is configured behind the display panel 22 and provides illumination to the display panel 22.

The backlight system 21 contains a light source 25, a uniforming device, and a back frame 23. The back frame 23 supports the light source 25 and the uniforming device 24. If this is an edge-lit backlight system 21, the uniforming device 24 is a light guide plate. If this is a direct-lit backlight system 21, the uniforming device 24 is a diffusing film. The back frame 23 contains at least a first main piece and a second main piece, jointly forming the main frame 27 of the back frame 23.

Of course the backlight system 21 can be structured according to any one of the embodiments described above.

It should be noted that the flat panel display device 20 can be a LCD device or a LCD TV.

The present invention further provides a 3D display device 30. As shown in FIG. 18, the 3D display device 30 contains a liquid crystal lens grating 31, a backlight system 32, and a display panel 33. The liquid crystal lens grating 31 is configured on a light emission plane of the display panel 33. The backlight system 32 can be structured according to any one of the embodiments described above (e.g., the backlight system 32 contains a back frame 23). The back frame 23 contains at least a first main piece and a second main piece, jointly forming the main frame of the back frame. The details are omitted here.

The present invention further provides a plasma display device 40. As shown in FIG. 19, the plasma display device 40 contains a plasma display panel 41 and a back frame 42 configured behind the plasma display panel 41. The back frame 42 can be structured according to any one of the embodiments described above. The details are omitted here.

The backlight system 21 of the above-mentioned embodiments further contains a reflection plate on the back frame, and behind the uniforming device 24 or a direct-lit light source. The purpose of the reflection plate is to reflect the light behind the back frame forward, so as to increase light utilization.

The present invention further provides a backlight system according to any one of the above-mentioned embodiments. The backlight system is capable of preventing the light leakage and the cave-in of the reflection plate.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A backlight system, comprising a uniforming device, a reflection plate, a back frame, and a PET (Polyethylene Terephthalate) substrate;
wherein the uniforming device is placed on the back frame with the PET substrate configured in between; the reflection plate is configured between the uniforming device and the PET substrate; the PET substrate is of color black; the PET substrate is adhered to the back frame; and the back frame comprises at least two main pieces jointly forming a main frame of the back frame.

2. The backlight system as claimed in claim 1, wherein the reflection plate comprises a substrate layer and a reflection layer on the substrate layer; and the substrate layer contacts the PET substrate.

3. A backlight system, comprising a uniforming device, a reflection plate, a back frame, and a PET substrate;
wherein the uniforming device is placed on the back frame with the PET substrate configured in between; the reflection plate is configured between the uniforming device and the PET substrate; and the back frame comprises at least two main pieces jointly forming a main frame of the back frame.

4. The backlight system as claimed in claim 3, wherein the PET substrate is of color black.

5. The backlight system as claimed in claim 4, wherein the reflection plate comprises a substrate layer, a reflection layer on the substrate layer; and an ink layer printed on a side of the substrate layer away from the reflection layer.

6. The backlight system as claimed in claim 3, wherein the PET substrate is adhered to the back frame.

7. A flat panel display device, comprising a display panel and a backlight system stacked together: the backlight system comprising an uniforming device, a reflection plate, a back frame, and a PET substrate;
wherein the uniforming device is placed on the back frame with the PET substrate configured in between; the reflection plate is configured between the uniforming device and the PET substrate; and the back frame comprises at least two main pieces jointly forming a main frame of the back frame.

8. The flat panel display device as claimed in claim 7, wherein the PET substrate is of color black.

9. The flat panel display device as claimed in claim 8, wherein the reflection plate comprises a substrate layer and a reflection layer on the substrate layer; and the substrate layer contacts the PET substrate.

10. The flat panel display device as claimed in claim 7, wherein the PET substrate is adhered to the back frame.

11. The flat panel display device as claimed in claim 7, wherein the back frame further comprises at least an auxiliary piece and a brace; the auxiliary piece is configured in the main frame and joined to the main pieces; the brace is fixed to the main pieces or the auxiliary piece; and the brace is for fixing a circuit board.

12. The flat panel display device as claimed in claim 7, wherein the main pieces comprises a first main piece and a second main piece; at least two joining section is configured at an end of the first main piece; each joining section is structured to match an end of a second main piece; and the first main piece is joined to a second main piece by having one of its joining sections connected to an end of the corresponding second main piece.

13. The flat panel display device as claimed in claim 12, wherein the joining sections are arranged at an interval along the length of the first main piece.

14. The flat panel display device as claimed in claim 13, wherein each joining section is an indentation on a surface of the first main piece whose shape matches an end of a second main piece so as to receive the end of the second main piece.

15. The flat panel display device as claimed in claim 13, wherein a protrusion is configured on a surface at the end of the second main piece; and the protrusion is received by a notch in the corresponding joining section so that the first and second main pieces are joined together.

16. The flat panel display device as claimed in claim 15, wherein there are at least two protrusions arranged at intervals on a surface along the length of the second main piece.
